(19) United States
(12) Patent Application Publication
(10) Pub. No.: US 2007/0279364 A1
(43) Pub. Date: Dec. 6, 2007

(54) LIQUID CRYSTAL DISPLAY DEVICE, DATA DRIVER THEREOF, AND DRIVING METHOD THEREOF

(75) Inventor: Sang Moon MOH, Cheonan-si (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/752,431

(22) Filed: May 23, 2007

(30) Foreign Application Priority Data
Jun. 1, 2006 (KR) 10-2006-0049181

(51) Int. Cl. G09G 3/36

(52) U.S. Cl. 345/100

(57) ABSTRACT

A liquid crystal display and driving method thereof which generate a desired gamma curve according to a selected gamma voltage include a reference voltage generator and a data driver. The reference voltage generator generates reference voltages and the data driver generates gamma voltages according to a data signal and the reference voltages, and outputs the gamma voltages to data lines. The data driver includes a plurality of strings, each string including a plurality of voltage division resistors connected in electrical series with each other, at least two selection resistors having different resistance values and which are connected in electrical parallel with each other and in electrical series with the voltage division resistors of at least one of the strings of voltage division resistors, and a selector which selects one of the at least two selection resistors.

This application claims priority to Korean Patent Application No. 2006-49181, filed on Jun. 1, 2006, and all the benefits accruing therefrom under 35 U.S.C. § 119, the contents of which in its entirety are herein incorporated by reference.

### BACKGROUND OF THE INVENTION

(a) Field of the Invention

The present invention relates to a liquid crystal display device and, more particularly, to a liquid crystal display device and driving method thereof which generate a desired gamma curve based upon a selected gamma voltage, providing an improved wide angle display quality of the liquid crystal display.

(b) Description of the Related Art

A liquid crystal display (“LCD”) is a thin, flat display device which displays an image by varying light transmissivity of liquid crystal cells arranged in a matrix form. The LCD device includes an LCD panel which displays a picture through a liquid crystal cell matrix and a driving circuit which drives the LCD panel. However, a conventional LCD device has a shortcoming in widescreen applications because of its narrow viewing angle. In order to improve the viewing angle, various techniques have been suggested.

Recently, a combined gradation method has been developed for improving the viewing angle of the LCD device, in which each sub-pixel is divided into a high gradation region represented by a high gradation gamma curve and a low gradation region represented by a low gradation gamma curve. The combined gradation method allows a balance between response time and display quality of the LCD device, improving wide angle visibility by combining high and low gradations for a signal sub-pixel. For this purpose, a gamma voltage generator generates a set of high gamma voltages and a set of low gamma voltages. Typically, the sets of high and low gamma voltages are derived from various gamma curves. However, the conventional combined gradation method does not provide a configuration for generating the various gamma curves. Therefore, it is desired to have an LCD device which generates desired gamma curves for high and low gamma voltages.

### BRIEF SUMMARY OF THE INVENTION

An exemplary embodiment of the present invention provides a liquid crystal display (“LCD”) device and a driving method thereof, including a data driver which generates a desired gamma curve according to a selected gamma voltage.

More specifically, one exemplary embodiment of the present invention provides an LCD device including a reference voltage generator which generates reference voltages and a data driver which generates gamma voltages on the basis of a data signal and the reference voltages and outputs the gamma voltages to data lines. The data driver includes a plurality of strings, each string including a plurality of voltage division resistors connected in electrical series with each other, a plurality of nodes, each node corresponding to an individual gamma voltage of the gamma voltages, each node located between contiguous voltage division resistors of each string, at least two selection resistors connected in electrical parallel with each other, having different resistance values from each other, and connected in electrical series with the voltage division resistors of at least one string, and a selector which selects one of the selection resistors to select a desired gamma curve.

### The selection resistors generate at least one of a highest and a lowest gamma voltage of the gamma voltages.

The strings of voltage division resistors generate the gamma voltages except for the at least one of the highest and the lowest gamma voltages.

The highest gamma voltage may correspond to a black luminance or a white luminance, and the lowest gamma voltage may correspond to the other luminance.

Another exemplary embodiment of the present invention provides a method of driving a liquid crystal display device, the method including generating gamma voltages except for at least one of a highest and a lowest gamma voltage of the gamma voltages with a plurality of strings, each string including a plurality of voltage division resistors connected in electrical series and generating at least one of a highest and lowest gamma voltages of the gamma voltages by selecting one of at least two selection resistors having different resistance values from each other.

The highest gamma voltage may correspond to a black luminance or a white luminance, and the lowest gamma voltage may correspond to the other luminance.

Another exemplary embodiment of the present invention provides a data driver for a liquid crystal display device, the data driver including a plurality of strings, each string including a plurality of voltage division resistors connected in electrical series with each other, a plurality of nodes, each node corresponding to an individual gamma voltage of a plurality of gamma voltages and located between contiguous voltage division resistors of the strings of voltage division resistors, at least two selection resistors connected in electrical parallel with each other, having different resistance values from each other and being connected in electrical series with the voltage division resistors of at least one string the strings of voltage division resistors, and a selector which selects one of the at least two selection resistors.

The at least two selection resistors generate at least one of a highest gamma voltage and a lowest gamma voltage of the gamma voltages.

The voltage division resistors generate the gamma voltages except for the at least one of the highest gamma voltage and the lowest gamma voltage.

The highest gamma voltage may correspond to a black luminance or a white luminance, and the lowest gamma voltage may correspond to the other luminance.

### BRIEF DESCRIPTION OF THE DRAWINGS

The above and other aspects, features and advantages of the present invention will become more apparent by describing in further detail exemplary embodiments thereof with reference to the accompanying drawings, wherein:

FIG. 1 is a block diagram of a liquid crystal display (“LCD”) device according to an exemplary embodiment of the present invention;

FIG. 2 is a block diagram of an exemplary embodiment of a data driver of the LCD device of FIG. 1;

FIG. 3 is a graph of a pixel voltage-transmissivity gamma curve according to an exemplary embodiment of the present invention; and

FIG. 4 is a graph of pixel gradation-transmissivity gamma curves according to an exemplary embodiment of the present invention.

### DETAILED DESCRIPTION OF THE INVENTION

The invention now will be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, a display device according to an exemplary embodiment of the present invention will be described in further detail with reference to the accompanying drawings.

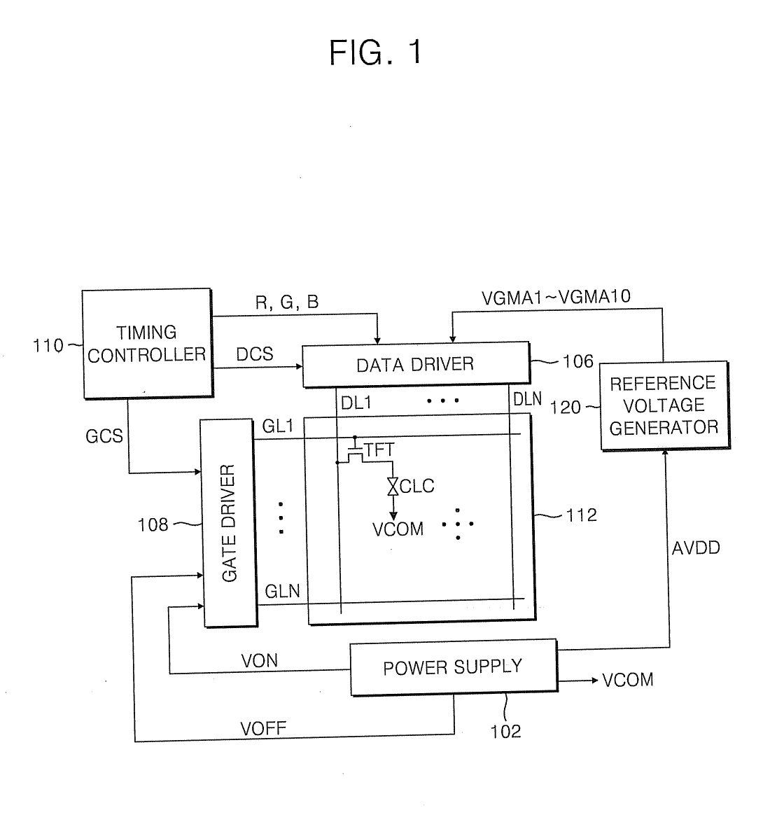

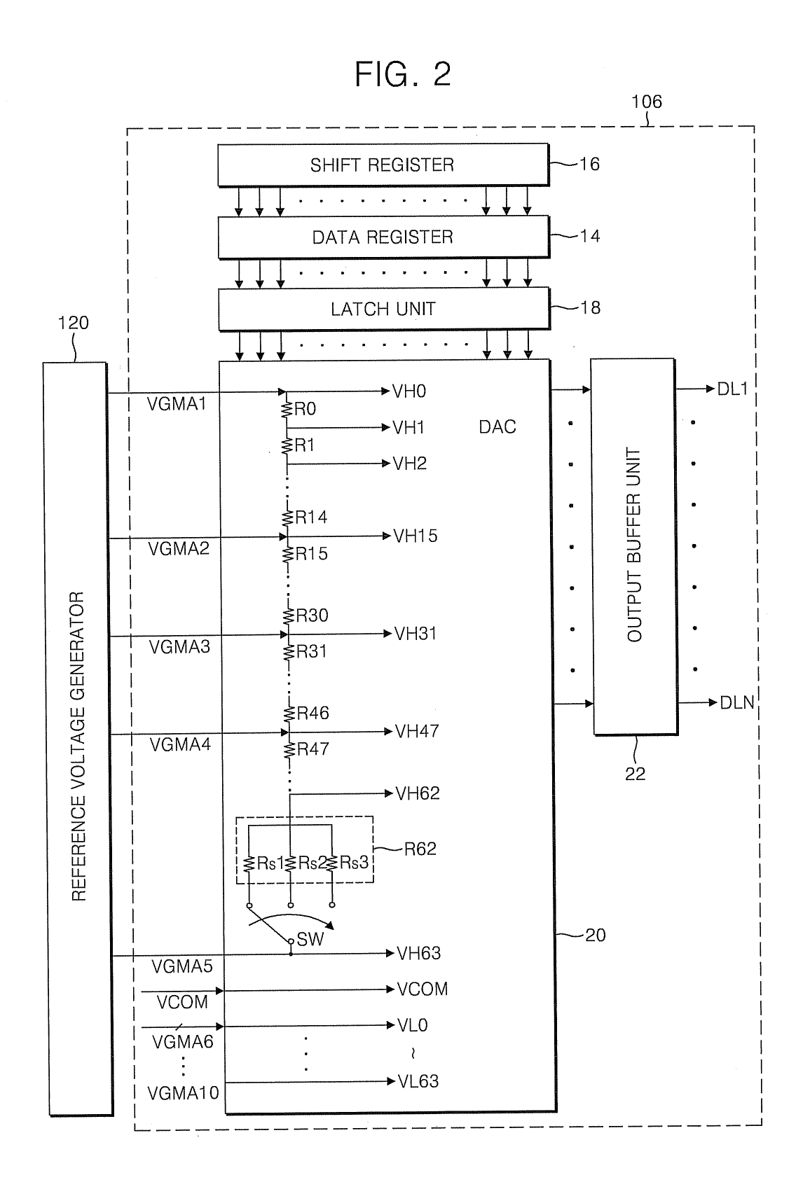

FIG. 1 is a block diagram of a liquid crystal display (“LCD”) device according to an exemplary embodiment of the present invention and FIG. 2 is a block diagram of an exemplary embodiment of the data driver of FIG. 1.

Referring to FIGS. 1 and 2, the LCD device includes a gate driver 108 which drives a plurality of gate lines GL1 to GLN arranged on an LCD panel 112, a data driver 106 which drives a plurality of data lines DL1 to DLN, a reference voltage generator 120 which generates positive reference voltages VGMA1 to VGMA5 and negative reference voltages VGMA6 to VGMA10 (hereinafter collectively referred to as “reference voltages”) and supplies the reference voltages to the data driver 106, a timing controller 110 which controls the data driver 106 and gate driver 108, and a power supply 102 which supplies a plurality of driving voltages to the gate driver 108, the data driver 106, the reference voltage generator 120 and the timing controller 110 (not all power connections are shown in FIG. 1).

A power voltage is supplied to the power supply 102 from an outside circuit (not shown), and the power supply 102 supplies the power voltage to the timing controller 110, the data driver 106, and the gate driver 108, including digital circuits (not shown), as a digital driving voltage (not shown). The power supply 102 generates a gate-on voltage VON and a gate-off voltage VOFF supplied to the gate driver 108 and generates a common voltage VCOM supplied to the LCD panel 112, using the power voltage. The power supply 102 also generates an analog power voltage AVDD supplied to the reference voltage generator 120.

The timing controller 110 generates a data control signal DCS and a gate control signal GCS which control driving timings (not shown) of the gate driver 108 and the data driver 106 with a vertical synchronization signal (not shown), a horizontal synchronization signal (not shown), a dot clock signal (not shown), a data enable signal (not shown), and input from outside circuits (not shown).

The gate driver 108 generates scan signals (not shown) according to the gate control signal GCS output from the timing controller 110 and supplies the scan signals to the gate lines GL1 to GLN. The gate driver 108 selects the gate-on voltage VON from the power supply 102 according to the gate control signal GCS of the timing controller 110 and supplies the gate-on voltage VON to the gate lines GL1 to GLN. While the gate-on voltage VON is not selected, the gate driver 108 selects the gate-off voltage VOFF and supplies the gate-off voltage VOFF to the gate lines GL1 to GLN.

The reference voltage generator 120 generates the reference voltages by using the analog power voltage AVDD output from the power supply 120 and supplies the reference voltages to the data driver 106.

The data driver 106 generates high gradation gamma voltages VH0 to VH63 and low gradation gamma voltages VL0 to VL63 (hereinafter collectively referred to as “gamma voltages”) according to digital data signals R, G, and B output from the timing controller 110 in response to the data control signal DCS and supplies the gamma voltages to the data lines DL1 to DLN of the LCD panel 112 through an output buffer unit 22.

The LCD panel 112 includes a thin film transistor TFT formed at an intersection of the gate and data lines GL1 to GLN and DL1 to DLN and a liquid crystal cell LCL connected to the thin film transistor TFT.

Further referring to FIG. 2, the data driver 106 includes a shift register 16, a data register 14, a latch unit 18, a digital-to-analog converter (“DAC”) 20, and the output buffer unit 22.

The shift register 16 sequentially generates sampling signals (not shown) by shifting a start pulse input (not shown) from the timing controller 110 (FIG. 1) according to a clock signal (not shown).

The data register 14 stores pixel data input from an outside circuit (not shown) in response to the sampling signals input from the shift register 16 and supplies the pixel data to the latch unit 18.

The latch unit 18 sequentially latches the pixel data supplied from the data register 14, and then simultaneously outputs the latched data to the DAC 20.

The DAC 20 uses the digital data input from the latch unit 18 to convert the references voltages into the gamma voltages, which are analog voltages, and outputs the gamma voltages to the output buffer unit 22. The DAC 20 selects the gamma voltages corresponding to the digital data input from the latch unit 18 and outputs the selected gamma voltages to the output buffer unit 22. In exemplary embodiment, the DAC 20 selects the positive reference voltages VGMA1 to VGMA5 or the negative reference voltages VGMA6 to VGMA10 in response to a polarity control signal (not shown) which is input from the timing controller 110 (FIG. 1).

More specifically, the reference voltage generator 120 supplies the positive reference voltages VGMA1 to VGMA 5 and the negative reference voltages VGMA 6 to VGMA10 to the DAC 20. The positive reference voltages VGMA1 to VGMA5 and the negative reference voltages VGMA6 to VGMA10 are divided by strings of voltage division resistors R0 to R62 and R63 to R125 (not shown in FIG. 2), respectively. Individual resistors within the strings of voltage division resistors are connected in electrical series, with nodes which correspond to more finely subdivided high gradation gamma voltages VH0 to VH63 and low gradation gamma voltages VL0 to VL63 between contiguous resistors, as shown in FIG. 2. (Hereinafter, the strings of voltage division resistors R0 to R62 and R63 to R125 are collectively referred to as “dividing resistors”). Put another way, the DAC 20 divides the positive reference voltages VGMA1 to VGMA5 and the negative reference voltages VGMA6 to VGMA10 using the dividing resistors to output the more finely subdivided high gradation gamma voltages VH0 to VH63 and the low gradation gamma voltages VL0 to VL63. In one exemplary embodiment of the present invention, but not being limited thereto, the high gradation gamma voltages VH0 to VH63 are generated by arranging n different dividing resistors (where n is a natural number greater than 1) between the positive reference voltages VGMA1 to VGMA5, e.g., between VGMA1 and VGMA2, between VGMA2 and VGMA3, between VGMA3 and VGMA4, and between VGMA4 and VGMA5, output from the reference voltage generator with reference to the common voltage VCOM, as illustrated in FIG. 2. In a similar manner, the low gradation gamma voltages VL0 to VL63 are generated by arranging n different dividing resistors between the negative reference voltages VGMA6 to VGMA10, e.g., between VGMA6 and VGMA7, between VGMA7 and VGMA8, between VGMA8 and VGMA9, and between VGMA9 and VGMA10, output from the reference voltage generator 120 with reference to the common voltage VCOM.

As a result, a voltage-transmissivity gamma curve is formed according to the high gradation gamma voltages VH0 to VH63 and the low gradation gamma voltages VL0 to VL63.

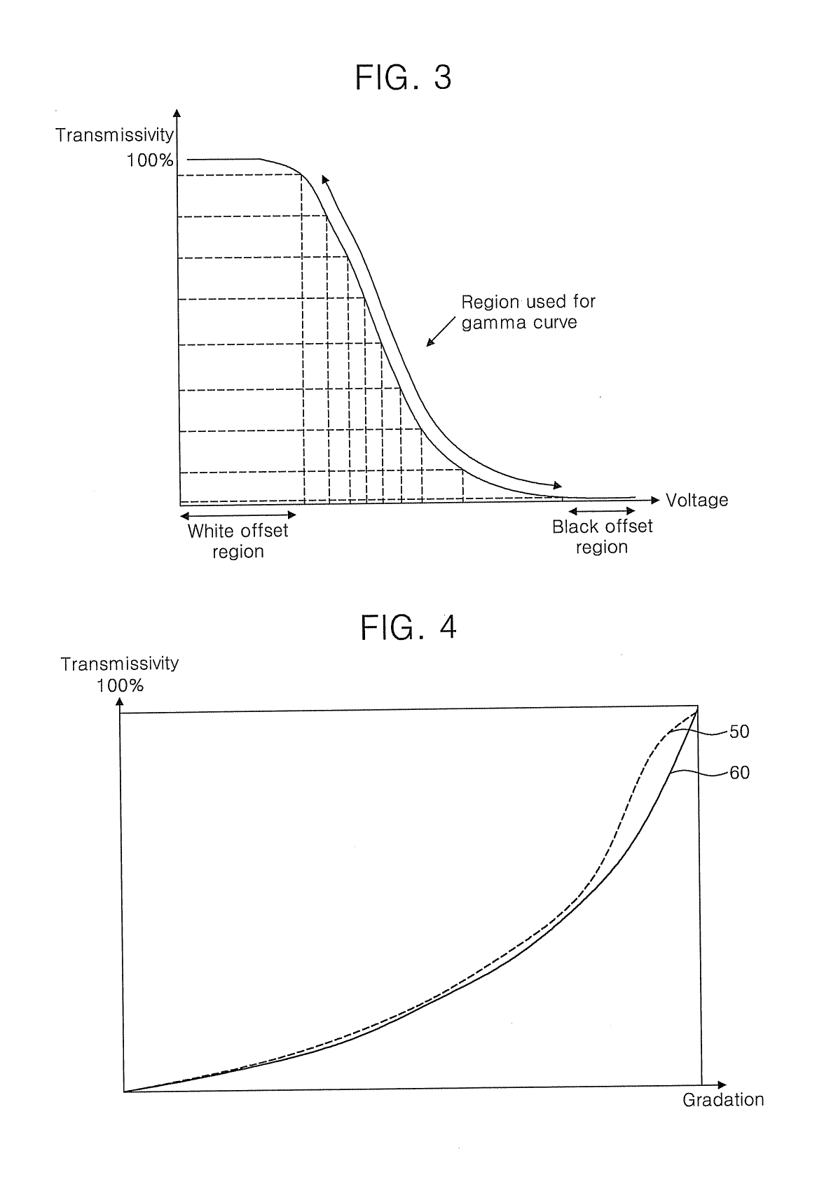

FIG. 3 is a graph of a pixel voltage-transmissivity gamma curve according to an exemplary embodiment of the present invention.

Referring to FIG. 3, a black offset region is a pixel voltage range in which transmissivity T is 0% such that the transmissivity does not vary significantly when the pixel voltage changes with respect to the common voltage, resulting in no image display. A white offset region is a pixel voltage range in which the transmissivity T is 100% such that the transmissivity does not vary significantly although the pixel voltage changes with respect to the common voltage, resulting in no image display.

Between the white and black offset regions, e.g., in the region used for a gamma curve as illustrated in FIG. 3, the gamma voltages are generated by the dividing resistors and selection resistors Rs1 to Rs3 (FIG. 2) to form a voltage-transmissivity gamma curve in which the transmissivity decreases as the voltage increases. The gamma voltages form a gamma curve which has an approximate “S” shape between the white offset voltage region and black offset voltage region to present a visible image, as illustrated in FIG. 3. Furthermore, by varying a highest voltage of the high gradation gamma voltages, e.g., VH63, alternate gamma curves may be formed, as shown in FIG. 4.

FIG. 4 is a graph of pixel gradation-transmissivity gamma curves according to an exemplary embodiment of the present invention.

Referring to FIG. 4, a highest high gradation gamma voltage VH63 forms a first gamma curve 50. In contrast, raising the highest high gradation gamma voltage, e.g., increasing high gradation gamma voltage VH63 relative to the common voltage VCOM, forms a second gamma curve 60 which has a white offset region which is narrower than the white offset region corresponding to the first gamma curve 50, as illustrated in FIG. 4. As further illustrated in FIG. 4, the second gamma curve 60 has a higher gamma value than the first gamma curve 50.

In order to select the desired highest high gradation gamma voltage VH63, e.g., to select a desired gamma curve, selection resistors Rs1 to Rs3 and a switch SW (FIG. 2) are used. Specifically, in one exemplary embodiment, 3 selection resistors are used, as shown in FIG. 2. In alternative exemplary embodiments, a different number of selection resistors may be used.

Referring again to FIG. 2, the first to third selection resistors Rs1 to Rs3 are connected in electrical parallel with each other, and constitute the dividing resistor R62. In alternative exemplary embodiments, the first to third selection resistors Rs1 to Rs3 may be connected in electrical parallel with each other and constitute another dividing resistor such as the dividing resistor R0, for example, but are not limited thereto. Furthermore, in other alternative exemplary embodiments or the present invention, the first to third selection resistors Rs1 to Rs3 may be connected in electrical parallel with each other and constitute another dividing resistor such as the dividing resistor R63 or the dividing resistor R125, for example, but are not limited thereto.

The first to third selection resistors Rs1 to Rs3 have different resistance values. In an exemplary embodiment, the selection resistors Rs1 to Rs3 have a relationship described by an inequality wherein the first resistor Rs1>second resistor Rs2>third resistor Rs3 in resistance value. Alternate exemplary embodiments may include selection resistors which have a different relationship, e.g. a relationship described by an inequality wherein the first resistor Rs1<second resistor Rs2<third resistor Rs3 in resistance value, but are not limited thereto.

The switch SW selects one of the selection resistors Rs1 to Rs3 in response to first to third selection signals (not shown), respectively, input through an option pin (not shown). More specifically, the switch SW selects the first selection resistor Rs1, which has a higher resistance than selection resistors Rs2 and Rs3, in response to the first selection signal to generate a highest high gradation gamma voltage VH63 to generate the first gamma curve 50, as described above.

The switch SW selects the second selection resistor Rs2 in response to the second selection signal to generate a highest subdivided high gradation gamma voltage VH63 having a lower voltage than the highest high gradation gamma voltage VH63 which is generated by the first selection resistor Rs1. Likewise, the switch SW selects the third selection resistor Rs3 in response to the third selection signal to generate a highest subdivided high gradation gamma voltage VH63 having a lower voltage than the highest high gradation gamma voltage VH63 generated by the second selection resistor Rs2. Further, when the third resistor Rs3 is selected, a gamma curve (not shown in FIG. 4) different from the first and second gamma curves 50 and 60 (FIG. 4) is generated, e.g., a gamma curve which has a wider white offset region than the white offset regions of the first and second gamma than curves 50 and 60.

Referring again to FIG. 2, a plurality of output buffers (not shown) within the output buffer unit 22 buffer the gamma voltages supplied from the DAC 20 and supply the gamma voltages to the plurality of data lines DL1 to DLN.

In summary, the LCD device according to an exemplary embodiment of the present invention generates a desired gamma curve by selecting one of the resistors Rs1 to Rs3 which generates a corresponding highest high gradation gamma voltage VH63 to generate the desired gamma curve.

According to one exemplary embodiment of the present invention described above, the LCD device includes the plurality of selection resistors Rs1 to Rs3 which select a desired highest high gamma voltage VH63. In another exemplary embodiment, however, an LCD device may include selection resistors which allow selection of a lowest low gamma voltage VH0.

In addition, in the LCD device according to one exemplary embodiment of the present invention, the white offset region is broad when the first gamma curve 50 is selected to increase a response time of the LCD device. Alternatively, the second or third selection resistor Rs2 or Rs3 which has lower resistance values than the first selection resistor Rs1 may be selected to compensate for display quality degradation at the white region, which allows a combined gradation method which provides improved visibility of the LCD device by combining high and low gradations for respective signal sub-pixels.

As described above, an LCD device and driving method thereof according to an exemplary embodiment of the present invention generates a desired highest high gradation gamma voltage by selecting at least one of a plurality of selection resistors in a digital to analog converter. Thus, the LCD device generates a desired gamma curve according to the highest high gradation gamma voltage.

The present invention should not be construed as being limited to the exemplary embodiments set forth herein. Rather, these exemplary embodiments are provided so that this disclosure will be thorough and complete and will fully convey the concept of the present invention to those skilled in the art. For example, exemplary embodiments of the present invention described herein generate gamma curves which have an approximate “S” shape between the white offset voltage region and the black offset voltage region (FIG. 3), e.g., the high gamma voltages correspond to black luminance and the low gamma voltages correspond to white luminance. In alternative exemplary embodiments, the high gamma voltages may correspond to white luminance and the low gamma voltages may correspond to black luminance.

It should be clearly understood that many variations and/or modifications of the basic inventive concepts herein taught which may appear to those skilled in the present art will still fall within the spirit and scope of the present invention, as defined in the following claims.

What is claimed is:

1. A liquid crystal display device comprising:
a reference voltage generator which generates reference voltages;
a data driver which generates gamma voltages on the basis of a data signal and the reference voltages and outputs the gamma voltages to data lines, the data driver comprising:
a plurality of strings, each string comprising a plurality of voltage division resistors connected in electrical series with each other;
a plurality of nodes, each node corresponding to an individual gamma voltage of the gamma voltages, and each node being disposed between contiguous voltage division resistors of each string of voltage division resistors;
at least two selection resistors connected in electrical parallel with each other, having different resistance values from each other, and connected in electrical series with the voltage division resistors of at least one string of the plurality of strings and
a selector which selects one of the at least two selection resistors.

2. The liquid crystal display device of claim 1, wherein the at least two selection resistors generate at least one of a highest gamma voltage and a lowest gamma voltage of the gamma voltages.

3. The liquid crystal display device of claim 2, wherein each of the voltage division resistors of the plurality of strings generates a respective gamma voltage of the gamma voltages except for the at least one of the highest gamma voltage and the lowest gamma voltage.

4. The liquid crystal display device of claim 3, wherein each of the highest gamma voltage and the lowest gamma voltage corresponds to a black luminance or a white luminance.

5. The liquid crystal display device of claim 1, wherein the selector is directly connected to one of the reference voltages.

6. A method of driving a liquid crystal display device, the method comprising:
generating gamma voltages except for at least one of a highest and a lowest gamma voltage with a plurality of strings, each string comprising a plurality of voltage division resistors connected in electrical series; and
generating at least one of the highest gamma voltage and the lowest gamma voltage of the gamma voltages by selecting one of at least two selection resistors which have different resistance values from each other.

7. The method of claim 6, wherein the highest gamma voltage corresponds to a black luminance and the lowest gamma voltage corresponds to a white luminance.

8. The method of claim 6, wherein the highest gamma voltage corresponds to a white luminance and the lowest gamma voltage corresponds to a black luminance.

9. A data driver for a liquid crystal display device comprising:
a plurality of strings, each string comprising a plurality of voltage division resistors connected in electrical series with each other;
a plurality of nodes, each node corresponding to an individual gamma voltage of a plurality of gamma voltages, and each node being disposed between contiguous voltage division resistors of the plurality of voltage division resistors;
at least two selection resistors connected in electrical parallel with each other, having different resistance values from each other, and connected in electrical series with the voltage division resistors of at least one of the plurality of strings of voltage division resistors; and
a selector which selects one of the at least two selection resistors.

10. The data driver of claim 9, wherein the at least two selection resistors generate at least one of a highest gamma voltage and a lowest gamma voltage of the plurality of gamma voltages.

11. The data driver of claim 10, wherein the plurality of voltage division resistors generates the gamma voltages except for the at least one of the highest gamma voltage and the lowest gamma voltage.

12. The data driver of claim 11, wherein the highest gamma voltage corresponds to a black luminance and the lowest gamma voltage corresponds to a white luminance.

13. The data driver of claim 12, wherein the highest gamma voltage corresponds to the white luminance and the lowest gamma voltage corresponds to the black luminance.

14. The liquid crystal display device of claim 9, wherein the selector is directly connected to one of reference voltages supplied outside.
